(19) United States
(12) Patent Application Publication
(10) Pub. No.: US 2021/0342130 A1
(43) Pub. Date: Nov. 4, 2021

(54) SYSTEMS AND METHODS FOR SOFTWARE APPLICATION GENERATION AND DELIVERY

(71) Applicant: Raul Sanchez, St. Louis, MO (US)

(72) Inventor: Raul Sanchez, St. Louis, MO (US)

(21) Appl. No.: 17/373,454

(22) Filed: Jul. 12, 2021

Related U.S. Application Data
(63) Continuation-in-part of application No. 16/868,309, filed on May 6, 2020, now Pat. No. 11,061,651.
Application No. 16/868,309 is a continuation of application No. 14/185,602, filed on Feb. 20, 2014, now Pat. No. 10,671,359.
(60) Provisional application No. 61/767,757, filed on Feb. 21, 2013.

(51) Int. Cl. G06F 8/38; G06F 8/36

(52) U.S. Cl. CPC G06F 8/38; G06F 8/36

(57) ABSTRACT

Systems and methods for providing and/or deploying complete application delivery via an application programming interface (“template-as-a-service” or a “template application programming interface”). An entire, complete application is provided in the response to an API call and merged with consumer-specific data to provide an access point for the application services for end-users. The consumer data may be merged into a complete application by the server or client side of the API call.

### CROSS-REFERENCE TO RELATED APPLICATION(S)

This application is a continuation-in-part of U.S. patent application Ser. No. 16/868,309 filed May 6, 2020, issued as U.S. Pat. No. 11,061,651, which is a continuation of U.S. patent application Ser. No. 14/185,602, filed Feb. 20, 2014, and issued as U.S. Pat. No. 10,671,359, and which claims the benefit of U.S. Provisional Patent Application No. 61/767,757 filed Feb. 21, 2013. The disclosures of both of these references are incorporated herein by reference in their entirety.

### BACKGROUND OF THE INVENTION

### 1. Field of the Invention

The invention relates generally to the field of software development. More specifically, the invention relates to computer systems and computer implemented methods that enable users to create new software applications using one or more parts of the existing software, and to a software delivery mechanism that connects software capability systems with software consumer systems to provide an infrastructure for complete application delivery using an application programming interface (“API”).

### 2. Description of the Related Art

The traditional approach to creating network-enabled applications requires the enterprise desiring to offer the application to develop some or all components of the application. The creation of computer applications usually involves the participation of multiple professionals. Developing a single application requires planning, design, prototyping, development, testing, and deployment. To build and deliver an application, it is required that one or many professionals follow a process that requires problem analysis, solution design, and application development. Although this process should lead to the creation of unique applications, applications that have the same purpose tend to look and behave alike. Development from scratch is time-consuming, laborious, and wasteful, because it duplicates work already performed by others to implement generic functionality, resulting in hundreds of design and development hours wasted. A process that aims to produce unique software applications, ultimately ends up generating solutions that are only slightly different from other existing software products of the same purpose. The work required to create a new application can be reduced by utilizing third-party solutions that provide some of the required functionality for such application.

The delivery of this functionality can be achieved using an application programming interface, or “API.” An API is a defined interface for interactions between disparate computing platforms or systems, and the API typically defines the scope of services or functions implemented by a given system or module and made available to others. The API defines how functionality is accessed (i.e., the naming conventions), as well as the types and format of data that will be provided to, or generated by, the API. APIs are preferred for a number of reasons, including system interoperability, information hiding, modular programming, and implementation independence. APIs are commonly thought of as being associated with system libraries, programming languages, and database software, but increasingly, the term API refers to a “Web API,” which can provide an API for a web server, web browser, or web application. However, even with an API, it remains the task of the developer to assemble the various unrelated third party solutions together into a coherent new application.

These problems have been identified by both companies and individuals. They have created software authoring tools that allow non-technical people to develop a software application, yet most software applications are developed by technical people. In this type of authoring tools the user interface is simplified to a point that all that users have to do is to create application interfaces by aggregating tiny elements such as texts, buttons, and images. Although these kinds of tools save a significant amount of time, compared to traditional development methodology, they also introduce new problems.

Specifically, these tools do not take into consideration that the user may have a clear vision of what he or she wants to create, so even simple application interfaces must be built by aggregation. Also, by oversimplifying the interface these authoring tools are less capable of solving real-world programming problems. These tools further do not offer the user ready-to-use design and code options, so the user does not have to reinvent the wheel when trying to address commonly known problems.

Additionally, software is now an integral part of the lives of most people around the world. Software is used to create, market, and deliver products that are enjoyed by all. Software is used to connect with people, work, entertainment, and manage personal health, finances, and more. The ability to create more and better software is key for the further progress of humankind. Although there has been a great improvement in people's lives that can be attributed to the growth in the software industry, technology moves faster than people's ability to adopt it and there is a growing need for solutions that will allow people to catch up with technology. However, the current paths for creating, implementing, and delivering technology solutions are only accessible to a small group of the population who have the know-how or who are in a position of investing the time required to learn how to create technology solutions.

Another challenge with software is delivery and control. It is not enough to merely create an application; it is desirable to provide a mechanism or process for efficient and reliable delivery and updating. The most traditional software delivery model is direct installation, where a copy of the software is installed in a customer's computing environment. In some instances, this copy can be further modified or customized in the customer computing environment. The customer computing system remains a closed system and any new functionality added via the modifications or customizations are not available to others. The customer has full control over the hardware, code, and data that make up the software.

Another common approach is to, effectively, outsource some features or functionality to a third party system. In this type of deployment, the software contacts third party systems to acquire specific types of external data, which is then transformed and formatted for use in the application. For example, a mobile application for a stock price widget may request historic price information about various stocks from a third party data API (e.g., Yahoo! Financial), which responds to the request with information that is formatted for display in the client application, such as in a line graph showing historical stock prices. The main benefit of this approach is that many customers can consume data from the same provider, allowing the client applications to better control the user experience, while providers only need to care about general-purpose use cases.

A still further deployment strategy is to shift the responsibility for processing data and returning the final output to a third-party server, and the client application simply displays the rendered content. That is, the client application uses the API call to interact with an external server that provides a final, formatted output that can render a function or feature within the client application. Data may be sent to the server by the client application, and the server processes it to create an output that is displayed largely as-is. This strategy is commonly used by ad networks to serve ads to websites and mobile applications, and social media platforms to allow packaging information inside a widget that can be embedded in the client application (e.g., to embed a Tweet with a blog post while preserving the look and feel of Twitter™).

However, all of these approaches have flaws, and what is needed in the art is a mechanism for delivering a complete application solution while reducing development time and avoiding duplication of effort, reducing update and maintenance time, while also maintaining customer control over the application.

Another challenge with on-line delivery of software services is the disjointed ecosystem of the World Wide Web. Developers spend most of their time connecting existing technologies that could be together, but are not. For example, there are over 75 million Wordpress™ web sites and the number is growing. Thousands of web developers create new web sites every day in their own way. The industry has not achieved standardization of the coding methodology; there is little conversation about standardizing delivery.

Thousands of ready-made templates are scattered across multiple online marketplaces where developers can buy code, but such marketplaces do not address the problem of delivering software code. They merely provide the buyer with an archive of files (typically a .zip file which includes the digital assets), leaving it to the buyer to install, modify, test, and publish a template in the developer's computer environment. Designers sometimes find that the template, which looks pleasing and functional in a controlled demonstration in the marketplace, is not a good fit for the designer's needs and data.

Websites, developers, and templates are not part of the same ecosystem. This requires integrations to be custom made on an ad hoc basis. What is needed is a way to unify how software templates are delivered over the internet regardless of the tools used to build them.

### SUMMARY

A system and method for organizing and classifying existing applications so as to enable users to create new applications using the one or more parts of existing applications. The system is capable of automatically generating a large number of template applications which are fully designed, coded, and ready-to-use. The system also automatically expands its catalog of template applications and screen components, which are categorized based on a specified purpose, whenever a user creates a new application or screen with the same purpose. In this way a user can simply specify the purpose of what they want to create, and the system will provide a ranked list of possibilities based on the actions of other users, and automatic generation mechanisms.

There is described herein, among other things, is a method for generating a set of ranked screens, the method comprising: providing a database of screen seeds and parts accessible by a computer processor and a user, each screen seed being capable of having at least one part positioned on a position thereon; the user: selecting a screen seed from the database; populating the screen seed with parts from the database until all the positions have a part populated thereon; assigning the screen a screen purpose; and repeating the providing, selecting, populating and assigning to create a set of screens, each of the screens in the set having the screen seed and the screen purpose; the computer processor: accessing the set of screens and giving each of the screens in the set of screens a lowest ranking; making at least one new screen, each of the new screens comprising: the screen seed populated with an unused combination of parts which parts have been previously populated on at least one of the screens in the set of screens; associating each of the new screens with the screen purpose; increasing the ranking of the screens in the set of screens; giving each of the new screens a lowest ranking; merging the new screens into the set of screens; and storing the set of screens on the database.

In an embodiment, the method further comprises: the user making a first application, the first application comprising two or more screens from the database; and the user assigning the first application an application purpose.

In an embodiment, the method further comprises: a second user, the second user making a second application, the second application comprising two or more screens from the database; and the second user assigning the second application the application purpose.

In an embodiment, the method further comprises: the computer processor examining the first application and the second application and: if the first application and the second application include any screens with a common screen purpose, then creating a minimum screen requirement for the application purpose, the minimum screen requirement comprising all the common screen purposes between the first application and the second application.

In an embodiment, the method further comprises: the computer processor: generating at least one application template for the application purpose, the application template including at least one screen; wherein, the application template meets the minimum screen requirement for the application purpose.

In an embodiment of the method, the computer processor suggests to a third user, the third user indicating to the computer processor that they want an application for the application purpose, at least one of the application templates for the application purpose.

In an embodiment of the method, the application is designed to be rendered on a client device.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a schematic outlining various screen seeds that may be generated from a screen layout having three parts (i.e., a header part, a footer part, and a content part);

FIG. 2 is a flowchart illustrating the workings of a system for organizing, classifying and generating software, according to an embodiment;

FIG. 3 is a schematic illustrating a graphical interface for selecting and previewing combination of parts, and assigning a purpose thereto, according to an embodiment;

FIG. 4 is a schematic illustrating exemplary screen combinations that have the same purpose;

FIG. 5 is a schematic showing exemplary contents of a virtual catalog and the application of a ranking algorithm;

FIG. 6 is a schematic illustrating exemplary user generated and system generated applications, according to an embodiment; and

FIG. 7 is a schematic illustrating a method to determine a minimum number and a maximum number of screens in an application being generated, according to an embodiment.

FIG. 8 is a schematic illustrating a system and method to implement a template-based application delivery system, according to an embodiment.

FIG. 9 is a schematic illustration of a template-based application delivery system, according to an embodiment.

### DETAILED DESCRIPTION

Embodiments of the present invention provide systems and methods for organizing and classifying existing software so as to enable users to create new software applications using the one or more parts of the existing software.

An embodiment of the proposed method makes a system capable of automatically generating millions of combinations of application screens and computer applications for known purposes. The generated screens and applications are fully designed, coded, and ready-to-use. Such an embodiment eliminates the need of long development processes; reduces the number of technical people required to build an application; and helps discover and evaluate hundreds of thousands of design variations so users can start creating applications with an end in mind.

Rather than providing a mechanism for users to create computer applications by typing source code, or aggregating small elements to build the required software interfaces, the proposed method and system offer a large catalog of predefined, fully designed, ready-to-use applications. The system also provides a mechanism for browsing and searching for screens and applications of known purposes. In this way the users can simply specify what is the purpose of the screen or application that the user wants to create, and the system will provide a ranked list of possible screens and applications that can fulfill the specific purpose. Users can create duplicates of these screen applications to customize them and make them their own.

Certain terms used in the detailed description are defined and described below.

Throughout this disclosure, the term “application container” refers to containers that allow for the grouping of the multiple screens that may be part of an application, which containers are referred to herein as application containers. An application container may handle rules for aggregating screens and the resources associated with those screens. The application container may serve as a mediator between the application screen and the devices where the application might be running, to allow the screens accessing the devices' software and hardware resources.

Throughout this disclosure, the term “application combination” refers to a concrete combination of multiple application screens (defined further below). The system may provide users with a graphical interface to aggregate one or more screens into a single group. An application combination might be made out of one or more screens.

Throughout this disclosure, the term “application data” refers to information the system may collect or aggregate that relates to each application or application instance, and this application data may include but it is not limited to, application globally unique identifier (GUID), application purpose, application friendly name. tags, categories, date of creation, date of last modification, metadata, et cetera.

Throughout this disclosure, the term “application full feature set” refers to the group of screens that are common and not common across all the applications of the same application purpose, makes up the maximum possible group of screens that can be used to build an application that contains all the features that may be consider for a single application with that application purpose. This group is determined by finding application combinations of the same purpose. FIG. 6 illustrates this concept, as described in more detail herein.

Throughout this disclosure, the term “application instance” refers to a consumer controlled container for an application. This is typically expected when a web server running on a computer is accessible to one or more individuals over an Internet connection or a private network. The application is initialized in an idle state and will transition to a rendered state once the application data and design are available. An application instance may be an editable copy of an application that a consumer or other user can customize such as by assigning user specific text, images, video, audio, design style, functionality and to populate and render using consumer-specific data. An embodiment may allow users to create copies of applications that have been added to the system.

Throughout this disclosure, the term “application minimum screen set” refers to the group of screens of similar screen purpose that are found across application combinations that have the same application purpose. The system may allow the user to assign a purpose to an application combination. Once the system detects two or more application combinations with the same purpose, the system can identify which screens within the applications of the same purpose, have the same screen purpose. FIG. 6 illustrates this concept, as described in more detail herein.

Throughout this disclosure, the term “application purpose” refers to the concrete use that a user may assign to an application. A single application may have one or more purposes. This concept also refers to the primary function performed by the application combination. For instance if the purpose of an application combination is “real estate”, individual screens of the application combination may perform the tasks of “displaying houses in a map” or “showing details of a single home”. In this scenario the main purpose of the application is still “real estate” and that is what the system may capture as application purpose.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wrist wear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or trackpad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “consumer” refers to a person or an external system receiving TAPI services and providing an access point for end-users to access and use an application. That is, a consumer is a “client” of the TAPI services, but is the “server” of the web application generating using those services to the consumer's own customers or clients.

Throughout this disclosure, the term “elements” refers to any portion of the screen that renders data such as, but not limited to, text, images, or video, should be considered an element. Any portion of the screen that is used to group text, images, video, or a combination of any number of these elements, should be considered an element. Any portion of the screen that allows users to provide input to the application in the form of text, voice command, mouse click, screen tap or touch, should be considered an element. The grouping of one or more elements makes up a part.

Throughout this disclosure, the term “end-user” refers to a person who ultimately uses or is intended to ultimately use the services provided by an application. The “end-user” is distinguished from a “user” more broadly in that the “end-user” is usually a member of the general public who desires to receive the commercial or other benefits of the application but do not necessarily have any technological expertise or stake in the application or technology itself. A “user” by contrast may include technological “users” of the system whose relationship to the application is more technical, such as system operations and administrators, software engineers, data administrators, and the like.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

Throughout this disclosure, the term “initial set of applications” refers to a graphical user interface for users to browse all available applications within the system and applications available in the system prior to any user interaction are considered the initial set of applications of the system.

Throughout this disclosure, the term “initial set of parts” refers to parts available in the system prior to any user interaction that are considered the initial set of parts of the system. The system may provide a graphical user interface for users to browse all available parts within the system.

Throughout this disclosure, the term “initial set of screens” refers to screens available in the system prior to any user interaction. The system may provide a graphical user interface for users to browse all available screens within the system.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “part data” refers to aggregate information the system may collect that relates to each part. This information may include, but it is not limited to, part globally unique identifier (GUID), part purpose, part friendly name, tags, categories, date of creation, date of last modification, metadata.

Throughout this disclosure, the term “part dependencies” refers to stored computer code that may be associated with each part sample. Possible embodiments of a part dependencies may include but is not limited to, computer code of the type HTML, CSS, JavaScript, PHP, Ruby, Python, CSV, JSON, Objective-C, Java, .NET, and XML amongst many others popular programming languages. Part dependencies may also refer to the associated binary code such as, but not limited to, images, animated images, video files, audio files, computer animations, portable document format (PDF), spreadsheets, archive files (ZIP, GZ, RAR, TAR, etc.). A part dependency may also be expressed in the form remote data that can be access via protocol such as, but not limited to, RESTFul or web API, SOAP, XML/HTML, or direct or indirect access to the client device's APIs that are available to application.

Throughout this disclosure, the term “part preview” refers to parts that include as part dependencies one or more images that represent the final look-and-feel of the specific part sample.

Throughout this disclosure, the term “related screens” refers to interconnected screens. Within an application, screens may link to each other. In such cases, the system considers those as related. The system may keep track of the interconnected screens, in order to make recommendations to the user about which screens may be combined when the user creates new applications.

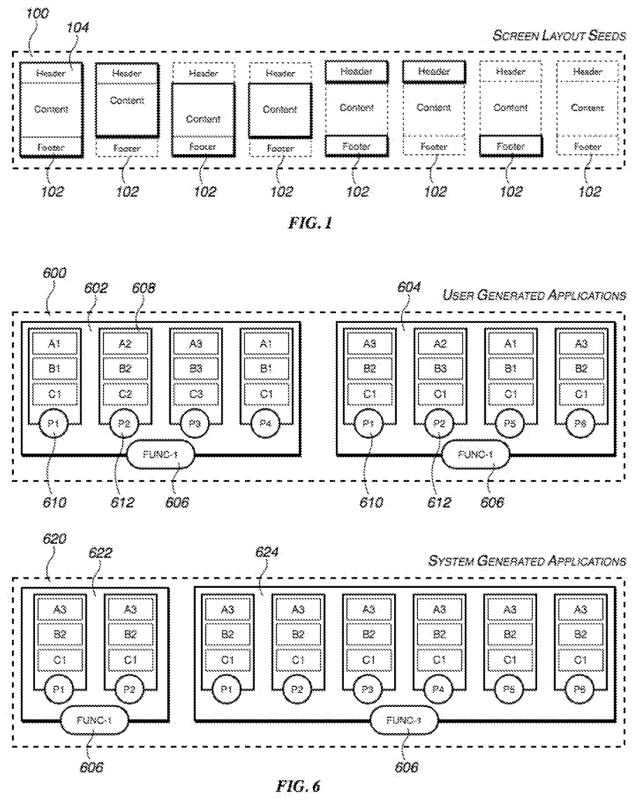

Throughout this disclosure, the term “parts” refers to the combination of visual elements within a screen, computer code, local or remote file resources, and data that might be stored within the system or a remote location. For example, FIG. 1 shows a screen made of three parts 104, i.e., a header area, a content area, and a footer area. These areas are considered parts 104. The system may store one or more samples of each part 104. The system may also allow users to create screens by combining samples of parts 104 available within the system.

Throughout this disclosure, the term “screen” or “screens” refers to a single state of an application, i.e., what the user sees at any given moment. Information inside the application may be presented to users in one or more screens. Each of these screens renders graphic elements that communicate to the user the information available in the application. This information may be, but is not limited to, images, text, animations, videos, and interactive visual elements. A screen may also present the user with graphic elements that will help capture data from the user or interact with the client device's software and hardware.

Throughout this disclosure, the term “screen data” refers to information the system may collect or aggregate that relates to each application screens, and this information may include but it is not limited to, screen globally unique identifier (GUID), screen purpose, screen friendly name, tags, categories, date of creation, date of last modification, metadata.

Throughout this disclosure, the term “screen layout” refers to the way in which graphic elements are arranged, positioned, sized, and displayed within the screen that is displayed on a client device. Within the system screens may be constructed using “parts”. In some embodiments, parts include, but is not limited to, header area, content area, and footer area. A possible screen layout might be a column where the header, content, and footer areas are stacked vertically, filling out the entire screen. FIG. 4 shows some possible embodiments with various layout alternatives.

Throughout this disclosure, the term “screen purpose” refers to the intended use that a user may assign to a screen. A single screen may have one or more purposes. This concept also refers to the primary function performed by the screen. In some embodiments for example, a screen may have purposes such as, but not limited to, contact form, list of items, photo gallery, map, and item details.

Throughout this disclosure, the term “screen seeds” refers to all the combinations resulting from creating variations of a single layout, by showing or hiding each part of the layout, are considered seeds. That is, within a screen layout, the different parts that comprise a screen might or might not be visible within the screen; for example, in some embodiments, the value of a header or footer may be set to none so that it is not ultimately displayed or rendered to an end user. For example, a screen layout containing parts such as header, content, and footer, generates 8 possible screen seeds. This number can be determined by using 2 values for each of the parts (visible and not visible), and multiplying that value by itself for as many time as parts are in the layout (2*2*2=8). FIG. 1 shows an example of screen seeds for a three part screen layout (header, content, and footer).

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, the term “source code” refers to a collection of human-readable computer instructions that the system may use to represent elements, parts, screens, and applications. Within the system, components and components relationships may be expressed in the form of source code. The system may allow users to add, delete, or modify source code.

Throughout this disclosure, the term “system intelligence” refers to the ability of the system of capturing, tracking, and computing users' inputs. Users' input might be, but are not limited to: the creation, editing, or deletion of parts, screens, or application (system components); assigning purpose to system components; naming or tagging system components; terms used to search system components within the system; explicit ranking of system components; and linking screens within an application. System intelligence also refers to: the system's ability to make recommendations to a user when he or she is creating a part, screen, or application; the ability of displaying and sorting information using data that might be relevant to an individual user such as, but not limited to, previous searches, previously used system components, related system components; the system's ability to analyze user generated content such as, but not limited to, parts, screens, and applications, and compare those types content against the system's database 252 to assess if the content is significantly different from the copies in the system, that originated that content. In such cases, the intelligence built into the system may import the new parts, screens, or application variations into the database and make them part of the system's initial catalogs.

Throughout this disclosure, the term “user” refers to a person or an external system that can make use of the systems and methods described herein. A user may have one or more roles within the system and such roles may define what the user can or cannot do.

Throughout this disclosure, the term “user data” refers to information collected or aggregated that relates to a user. This information may include but it is not limited to, user globally unique identifier (GUID), email addresses, roles, related website URLs, username, categories, date of creation, date of last modification, system usage logs.

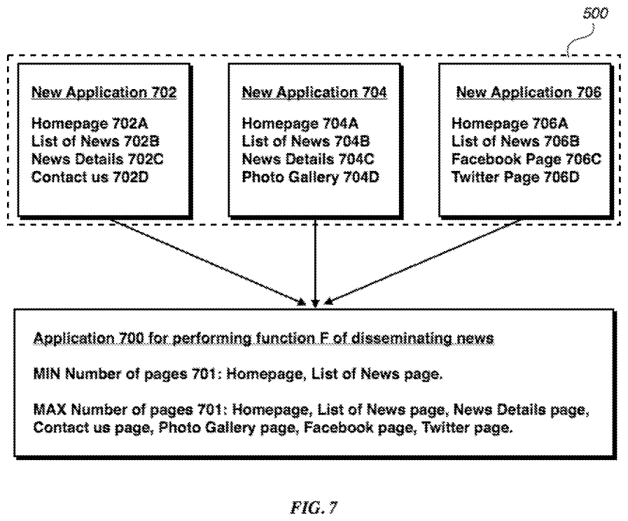

Throughout this disclosure, the terms “virtual catalog” and “application database” refer to the maximum number of unique screen combinations that can be generated using the available parts. That is, for a given screen layout, and given number of parts compatible with that screen layout, the system can automatically generate all the possible screen combinations that may result from permuting parts within the layout. For example, in some embodiments, a screen layout might be made out of a header area, content area, and footer area. In a scenario where there are 10 available part samples for each of the screen layout areas (header, content, and footer), the system may generate a catalog of screens with 1000 screen combinations. The addition of new parts to the system will exponentially increase the number of screens inside the virtual catalog 500. Similarly, the addition of new screen layouts will also increase the total number of possible screen combinations. FIG. 5 shows schematics of a possible virtual catalog that results from a 3 parts layout (header, content, and footer), and uses 3 samples for each part to generate a virtual catalog of 27 possible screen combinations.

Throughout this disclosure, the term “web,” refers to the global information sharing system for the storage and retrieval of documents and other resources via the Internet using certain communication protocols and addressing schemas for the transmission and rendering of such materials. The web uses Uniform Resource Locators (URLs) as the addressing space for documents and resources, and uses the HyperText Transfer Protocol (“HTTP”), and/or similar and/or related protocols including but not limited to HTTP Secure (“HTTPS”) and Secure Hypertext Transfer Protocol (“SHTP”) for communication and exchange. Documents are generally encoded using the HyperText Markup Language (“HTML”). Throughout this disclosure, the term “web application” or “web app” is application software that runs on, or via, a web server and is accessed remotely over a network by a client to receive services. Applications are usually a combination of text-based data, binary data, GUI elements, /or multimedia content, and/or references to external resources that, when combined, provide a set of functionality for a specific purpose. For example, Twitch™ is a web application for live streaming multimedia content, usually video games.

Applications may be presented to users in the form of non-compiled or compiled data resources (i.e., files), that the users' devices are capable of rendering. Within the application, the end user can perform tasks that may involve retrieving information from a local or remote database, collecting information provided by the device hardware and sensors (i.e., camera, microphone, proximity sensor, motion sensor, ambient light sensor, gyroscope), collecting information provided by the user, storing the collected information, analyzing and processing the collected information, et cetera.

A “web page” is generally a single document, usually encoded using the HTML standard. A “web site” is generally a collection of web pages serving a related purpose, and which reference and interlink to each other. In the early days of the web, web pages and web sites were largely static, meaning the underlying encoded content of the pages did not change in response to user interactions. If different or additional content was to be displayed, a new or different web page must be loaded and rendered, causing the web browser to “reload” or “refresh.” Later technologies, such as Asynchronous JavaScript and XML (known as “Ajax”), were developed to allow the underlying code to the page to be updated or changed without reloading the page, eventually giving rise to the creation of “web applications.”

A “web server” is a computer receiving and responding to HTTP requests for access to resources managed or controlled by the computer. The term “server” can refer to the web server software itself, the machine or collection of machines on which it runs, or a logical combination of both to provide web server functionality. Likewise, a “web client” is a computer having a user agent sending, and receiving responses to, such requests, and the term may refer to the computer itself, the user agent software, or a logical combination of the two to provide web client functionality. The user agent is most commonly web browser software programmed to render documents encoded in the HTML standard, but this is not always the case and the HTTP family of protocols can be used to exchange any type of information.

Attention is directed now to the Figures. FIG. 1 shows a schematic of an example of a basic screen layout 100 made out of 3 parts 104 (header, content, and footer). By displaying or hiding the areas of the layout, the system can determine what is the number of screen variations 102 that can be generated for a given screen layout. This number is the result of using 2 values for each of the parts (visible and not visible), and multiplying that value by itself for as many times as parts are in the layout. For example, in FIG. 1, the number of screen variations 102 that can be generated from this 3 part layout is 8 (2*2*2=8). While FIG. 1 shows a possible embodiment of screen seeds for a three parts screen layout (header, content, and footer), people of skill in the art will readily appreciate that layouts made out of a larger number of parts may be used and that they will produce a larger number of screen variations 102.

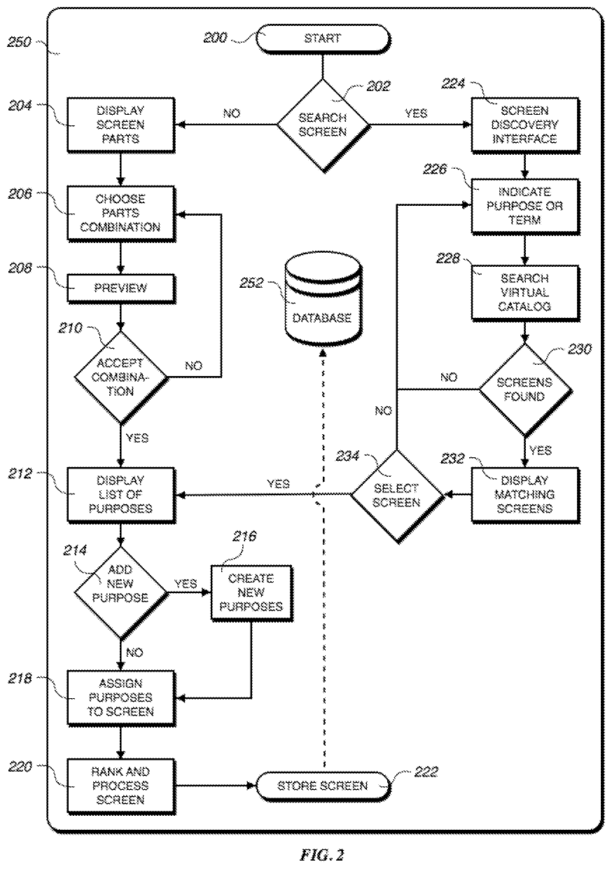

FIG. 2 shows a method 201 of using the system 250 for the creation of new application screens. The method 201 may begin at step 200, and at step 202, the user may be able to choose between: (i) searching for an existing application screen; or (ii) create his or her own application screen combination. If the user chooses to create a new application screen, the system 250 at step 204 may present a graphic interface that displays the different parts 104. From the parts user interface, at step 206, the user may choose a combination of parts that together will make up an application screen. FIG. 4, for example, shows three possible combinations of application screens 400, 402, 404.

At step 208, the system 250 may present the user with a graphical interface to preview the combinations of the chosen parts in real time. Once the user is satisfied with the chosen combination, the system 250 may prompt the user to accept the combination at step 210.

If the part combination is accepted by the user at step 210, the system 250 may display a graphic interface with a suggested list of screen purposes at step 212. A screen combination may be associated with one or more purposes. Users may use the system 250 to add new purposes at step 214 if the desired screen purpose is not part of the suggested list of purposes. If the user chooses to add a new screen purpose via the system 250 at step 214, he or she may be presented with a graphical interface at step 216 to add the new purpose. The system 250 may automatically associate the new purpose to the screen combination at step 218. If the user chooses a screen purpose from the purpose list at step 212, the selected purpose will be associated with the screen combination at step 210.

Once a screen combination has been accepted at step 210, and a purpose has been assigned at step 218, the system 250 may inspect the virtual screen catalog 500 and rank the screen combination at step 220. The system 250 may perform additional processing at step 220, such as processing that involves comparing the screen combination with purpose to other screens that may have the same purpose. After the screen combination has been ranked, the system 250 may store the screen association under the user's profile at step 222.

Alternatively, or in addition, the system 250 may present the user with a graphic interface to search or browse for existing screens at step 202. Specifically, the system 250 may present a graphic interface for the user at step 224, and instruct the user to specify the purpose of the screen he or she is looking for at step 226. Alternatively, the user may also specify terms of keywords to discover application screens at this step 226. Terms or keywords may include but are not limited to, screen names, categories, descriptions, tags, metadata, file resource names, or any other data associated with the screen within the system 250. Using the purpose, term, or a combination of both, the system 250 may inspect at step 228 the virtual catalog 500 to find application screens or part combinations with similar purpose, or that contain similar terms.

If, however, no matches are found at step 230, the system 250 may present the user with additional recommendations, or loop back to step 226 where the graphic interface may allow the user to indicate a different purpose or term. If the system 250 finds other screens within the virtual catalog 500 that match the purpose or term at step 230, the user may be presented with a graphic interface that will display a list of matching screens at step 232 organized by, but not limited to, ranking, alphabetical, date of creation, popularity, and other information related to the screens that is managed by the system 250.

The user may create a new screen from an existing one, by selecting a screen from the list of screens that matched the previously indicated purpose or term at step 234. The system 250 may allow the user to specify a new purpose or term at step 214 to the selected screen. The user may also choose to re-assign the same purpose to the screen selected at step 234. Once the user assigns a purpose, the system 250 may rank and process the screens against other screens previously created within the system 500 at step 220, as discussed above and in more detail below. Finally, the screen may be stored and associated with the user's profile at step 222.

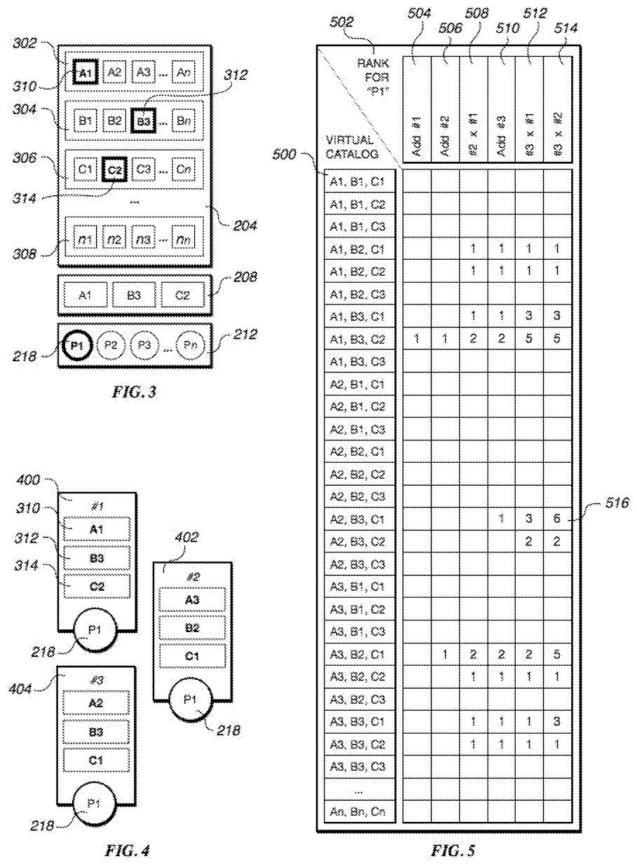

FIG. 3 shows schematics of an example of a parts selector graphic interface (as at step 204 of the method 201), the parts preview step (i.e., step 208 of the method 201), and the displaying of the purpose list (as at step 212 of the method 201). Within the parts selector graphic interface, the system 250 may group parts of the same type or kind inside a group, such as groups 302, 304, 306, and 308 in FIG. 3. In the schematic at FIG. 3, the part group 302 may represent a screen header area, the part group 304 may represent the screen content area, and the part group 306 may represent the screen footer area. The database 252 does not limit the number of part groups that can be displayed to the user from a graphical interface. When a user selects parts from the available part groups (310, 312, 314), the selected parts combination is displayed in the preview area (as at step 208 of the method 201). In the preview area, the system 250 may present to the user an interactive representation of the final assembled screen that contains the selected parts (310, 312, and 314, in this example). FIG. 3 also shows schematics of the list of screen purposes 212. Before a user can store a screen combination in the system, he or she may associate the screen combination (310, 312, and 314) with a specific purpose P1 (as at step 218 of the method 201).

FIG. 4 shows schematics of possible screen combinations 400, 402, 404 that may be created using the parts selector graphical interface (as at step 204 of the method 201). Along with the different parts 310, 312, 314, each screen is associated with at least one screen purpose. In FIG. 4 the screen #1 400, #2 402, and #3 404, have the same screen purpose P1.

FIG. 5 shows a combination of the virtual catalog (or application database) 500 and a screen ranking table 502. The virtual catalog 500 shows all possible screen combinations according to the parts shown in FIG. 3. The ranking table 502 shows a simulation of how the screens with the same purpose P1 will rank as new application screens are added to the system 250. When the screen #1 400 is added to the database 500, the system 250 may assign to it a ranking unit 516; when the screen #2 402 is added to the database 500, the screen #2 may also be assigned the ranking unit 516. Once the system 250 detects two or more screens of the same purpose P1, the system 250 may generate a subset of screen combinations within the virtual catalog 500 by permuting the different parts of the screens of the same purpose stored P1 within the system. By processing screen #1 400 and #2 402, the system 250 may be capable of identifying screens within the virtual catalog 500 that might serve the same purpose P1. Each of the screens within the subset may get a ranking unit. The final ranking after processing screen #1 and screen #2 (as in column 508 of the table 502), shows that the originally added screens rank higher. As more screens with the same purpose P1 are added to the system, the subset of screens that can serve the same purpose is larger. After processing the screen #3 against screen #1 (as at column 512) and screen #2 (as at column 524), the system 250 may be capable of identifying screens that have higher probability of serving the same purpose P1, even if the screen combination was not originally generated by the end user.

FIG. 6 shows schematics 600, 620 of user generated and system generated applications, respectively. The applications 602 and 604 in the schematic 600 may have the same application purpose 606, and contain multiple screens 608. In these schematics, the screens with purpose P1 (610), and purpose P2 (612), are common amongst the 2 user generated applications. When 2 or more applications of the same purpose are added to the database 252, the system 250 may determine what is the minimum number of screens and their purposes that are required to generate applications of the same application purpose 606.

The applications 622 and 624 in the schematic 620 are system generated applications. Both have the same application purpose 606 as the applications 602 and 604. The application 622 is the result of analyzing user generated applications of the same purpose 606, and extracting the screens that are common amongst those applications 602, 604. The application 624 is the result of aggregating common and non-common screens from user generated applications of the same purpose 602, 604.

Thus, as can be appreciated, the present invention relates to systems and computer implemented methods to generate, classify, and discover computer applications for a given purpose. An application purpose P refers to the concrete use that the user may give to the computer application or computer application screen. Users of the system 250 can create, edit, classify, and delete system components such as parts, screens, layouts, and applications. To manipulate these components the system may present the user with graphical interfaces where the user can search, browse, select, name, tag, create, duplicate, alter, remove, archive, combine, compile, and export system components. Further, within the system 250, users can:

Authenticate: using login credentials a user may access information that is available to all users as well as user-specific information such as settings, application and screen instances, resources, profile data, historical application performance and analytics.

Browse or search database 252: the database 252 contains initial sets of parts 104, screens, and applications that are made available to all users. The system 250 may present users with a graphical interface on a client device to browse and search information such as parts 104, and screens from the virtual catalog 500 (as at step 224 of the method 201), and applications within the system. The system 250 may also provide additional graphical interfaces for the user to inspect applications and their respective resources (i.e., related source code, data, or images). These graphical interfaces may allow users to perform advanced discovery of system components. The advanced interface may allow filtering search results using components name, description, date of creation, tags, resource, group name, and purpose. In some embodiments, when searching or browsing using the component purpose, the list of components will include user generated and system generated components.

View global search results: the system 250 may present users with a graphical interface that displays lists of parts, screens (such as at step 232 of the method 201), applications, or resources that are the result of a browse or search action. The user may inspect, preview, utilize, or duplicate one or more components from the result list.

Create new screens: the system may present a user with an interface containing collections of parts that are grouped by similarity (as at step 204 of the method 201). Parts that perform similar functions, or which may be required to be located in the similar areas within the screen layout, are grouped together for easy selection and discovery (such as parts 302, 304, 306 in FIG. 3). The user can select one or more parts from each collection (such as from groups 310, 312, 314 in FIG. 3). As the user selects parts 104, the system 250 may show a real time preview (as at step 208 of the method 201) of all the parts combined in the form of a single application screen (FIG. 4 shows schematics of possible parts combinations). Once the user is satisfied with his or her selections, the user may assign a purpose P and a custom name to the combination (as at step 218 of the method 201). The combination will be associated with the user's profile along with the custom screen name (as at step 222 of the method 201). The user may also tag the created screens. User tags may be used by the system to determine similarities between screens and allow the user to browse for screens (as at step 224 of the method 201).

Specify the purpose of a screen: once the user has created a screen combination, the system 250 may present the user with a graphical interface listing possible purposes P (e.g., P1, P2, P3, et cetera) or usages for an application screen. The user can select a purpose from the list and associate that purpose with the screen (as at step 218 of the method 201). The system 250 may check for screens with the same purpose P that have been previously created by users, and automatically identify screens within the virtual catalog 500 that can be used for the same purpose.

Tag screens: similarly to specifying the purpose of a screen, the system 250 may present the user with a graphical interface where the user can select tags from a list of predefined tags, and associate the selected tag with a screen. If the desired tag does not exist, the system may present the user with a graphical interface to allow the user to suggest a new tag, and add that tag to the database 252. The system will maintain an association between the screen, the user, and the tag, to allow the user to discover screens using tag names.

Rank screens: when a user creates a screen, the system 250 may collect information about the parts used by the user to create that screen, tags applied to screens, and the purpose P of each screen, and combine that data with similar information acquired from other screens. Using this information, the system may automatically identify screens of the same purpose within the virtual catalog 500. In FIG. 5, ranking table 502 shows a ranking process followed by the system 250 in some embodiments. In some embodiments, every time that a user creates a new screen, the system 250 may automatically assign a rank unit to that screen combination within the virtual catalog 500. A rank unit is generally a number assigned by the system and associated with an element of the system such as a screen. In addition to this, the system will inspect the virtual catalog 500 looking for user generated screens with the same purpose. If any screen is found, the system may run permutations between the parts of the newly created screen and the parts of any existing user generated screen of the same purpose (e.g., as shown in columns 508, 512, 514 of FIG. 5). Any screen combination that is discovered during the permutation process will be ranked. The permutation of the user generated screens of the same purpose P (e.g., purpose P1 in FIG. 5), allows the system 250 to automatically identify a subset of screens that can serve the same purpose. As a result of using this method, the system 250 may be able to identify and rank a subset of screens within the virtual catalog 500, which can be used for the same purpose P for which they were ranked. Screens that rank higher (i.e., have a higher rank value) are those that both, the users and the system, have identified as a good combination for a given purpose P. The system 250 may provide additional graphical interfaces for the user to assign positive or negative rank to increase or decrease the rank value. In such cases, the total rank value of the screen combination rank 516, within the virtual catalog 500 may decrease by one or more rank units. A higher rank value might be evidence that the screen combination is more suitable for the purpose for which the screen was ranked. Some embodiments of the system 250 may present the user with a graphical interface to discover application screens within the virtual catalog, using a screen purpose 218. The system 250 may choose to return the list of matching screens ordered by the screen rank value in an ascending or descending way.

Rank unit: the ranking process involves increasing or decreasing the rank of a screen by a numeric value. The system 250 considers this numeric value the rank unit. Some embodiments of the system may choose to represent this number with the integer one (1). During the ranking process a screen may be ranked with one or more rank units.

Browse and search applications: in some embodiments, the system 250 may present users with a graphical interface to browse and search applications. The system 250 may present the user with additional graphical interface to perform advance discovery of applications. The advanced interface may allow filtering search results using, for example, application name, tags, and purpose. When searching or browsing using the application purpose, the list of screens may include user generated and system generated applications.

View application search results: the system 250 may present users with a graphical interface that displays lists of applications that are the result of a browse or search action. The user may inspect, preview, utilize, or duplicate one or more applications from the result list.

Create a new application: the system may present a graphical interface for the user to combine one, two or more screens into an application template. To store an application within the database 252, the user may have to assign a name, and a purpose to the created application. The system will maintain a data relationship between the combination of screens, the user, the application purpose, and any additional data provided by the user in regards to the newly created application. The system 250 may use this information to allow the user browse and search applications stored within the database 250.

Specify the purpose of an application: once the user has created an application, the system 250 may present the user with a graphical interface listing possible purposes or uses for an application. The user can select a purpose from the list and associate that purpose with the application. The system 250 may check for applications with the same purpose P that have been previously created by users, and automatically identify what is the minimum set of screens that are required to create applications of the same purpose, and what is the maximum set of screens that will correspond to an application with all the possible screens required for that application purpose. The minimum and the maximum sets of screens will be stored in the database 252 in the system 250. The system 250 may use this information to allow the user to browse and search applications of that purpose that have been automatically generated.

Tag an application: similar to specifying the purpose of an application, the system may present the user with a graphical interface where the user can select tags from a list of predefined tags, and associate the selected tag with an application. If the desired tag does not exist, the system 250 may present the user with a graphical interface to allow the user to suggest a new tag, and add that tag to the catalog 500. In some embodiments, the system 250 may maintain an association between the application, the user, and the tag, to allow the user to discover applications using tag names.

Auto-generate applications: FIG. 6 shows how the system 250 can automatically generate applications from user generated applications. When a user creates an application (e.g., applications 602, 604 in FIG. 6), the system 250 automatically inspects the database 252 and looks for other user generated applications of the same purpose P (e.g., purpose P1 at 610 in FIG. 6). If other applications are found, the system 250 may automatically identify combinations of screens that may produce applications of the same purpose. As can be seen in FIG. 6, both user generated applications 602, 604 contain variations of screens with the purpose P1 at 610, and P2 at 612. Once the user adds to the applications database 252, an application combination that has the same application purpose 606 of previously added application combinations, the system 250 can compare all user generated application combinations of that purpose 606, and determines how often an single screen purpose appear across all user generated applications of the same purpose 606. If some screens of particular screen purposes are frequently used, the system 250 can safely assume that possible embodiments of a new application 622 for the application purpose 606, should include screens of the screen purposes 610, 612, that are commonly used in user generated applications of the same application purpose 606. In FIG. 6, application 622 shows a possible embodiment of a system generated application combination. This is the result of identifying screens with the purposes P1 and P2 (610 and 612 respectively), that are present in user generated applications of the same application purpose. The embodiment 622 is then a system generated application that aggregates only screens with screen purposes 610, 612 that are frequently used across user generated applications of the purpose 606. Similarly, the system can perform additional processes to analyze newly added user generated application, and identify screens of the same screen purpose P1, P2 (610 and 612 respectively) that are frequently used across all user generated applications of the same purpose 606, and screens of different purpose that are use across the same group of user generated applications. Application 624 shows a possible embodiment of a system generated application of the purpose 606, which is the result of combining a single instance of every screen purposes, used in user generated applications of the purpose 606. To automatically generate a system application combination, the system 250 may use screen combinations created by the user, as well as screens of the corresponding purposes that might be available in the virtual catalog 500. The application combinations that result from these permutations will be stored in the database 252 in the system 250, and associated with the application purpose 606 for which the permutations were done.

Rank applications: all applications within the system 250 are ranked. For example, if a user creates an application with a purpose 606, that application gets a rank unit. A rank unit might be assigned to an application combination in situations such as, but not limited to: the user generates an application; the system 250 auto-generates an application combination; and the user creates copies of an application.

Browse and search applications: some embodiments of the system 250 may present the user with a graphical interface to discover applications using a known (i.e., a preset) application purpose 606. The system 250 may present the user with additional graphical interface to perform advance discovery of applications. The advanced interface may allow filtering search results using application name, tags, and purpose. When searching or browsing using the application purpose, the list of applications will include user generated and system generated applications. The system 250 may choose to return the list of matching applications ordered by the application rank value in an ascending or descending way.

View applications search results: the system 250 may display a list of applications in a graphical interface when users browse or search for applications. The user may inspect, preview, utilize, or duplicate one or more applications from the search result list.

Create an application instance: the system 250 may allow users to create instances of applications. The system 250 may present the user with a graphical interface to find and select applications and create duplicates of one or more applications that can be edited.

Edit application instances: the system 250 may allow users to edit the source code and resources of an application instance. The system 250 may provide users with a graphical interface to add, remove, or modify resources and source code of an application instance.

Analyze application instances to create new parts 104: the system 250 may inspect user generated application instances. The system may compare the different parts 104 of any application instance against the initial set of parts within the system 250 (as at step 204 of the method 201). When the user edits an application instance it is expected that the parts within that application instance will differ from the parts from which they were originated. If the application instance parts are considerably different, the system 250 may identify and replace the user's custom information such as, but not limited to text labels, text paragraphs, and images, and import the processed part into the initial set of parts.

Publish applications: the system 250 may export parts, screens, and applications in the forms of: uncompressed code to be consumed by client devices that are capable of rendering web content (HTML, CSS, JavaScript, text, images and media files)—the uncompressed version may be accessed from the system or from an external system. The system is also capable of transferring the web content to a remote server using protocols such as FTP, SFTP, SSH, HTTP, HTTPs, MLLP, OFTP, OFTP2, RN IF, SMTP, SMTPs, WS; archive files to allow the download of the parts, screens, or application and their related source code and resources; and compile the application as a package to allow installations in client's devices as native code.

Thus, as has been described, the system 250 may organize and classify automatically generated computer applications, and can automatically generate millions of computer application screens without human intervention. By breaking application screens into combinable parts 310, 312, 314, the system 250 can perform permutation to generate the required visual, logical, and data elements that comprise each application screen.

Further, the system 250 may automatically generate millions of computer applications without human intervention. Applications within the system 250 have one or more screens. By combining screens (see Screens), the system 250 can perform permutations to create interconnected screens and generate the required visual, logical, and data elements that comprise each application.

The system 250 may automatically determine the minimum number of screens required to create applications for a given application purpose (see Specify the purpose of an application).

The system 250 may generate a virtual catalog 500 of screens from combining parts within the database 252. The system 250 may inspect the virtual catalog 500 and automatically generate new applications for a given purpose without additional input from users.

By analyzing user generated applications for a concrete purpose, the system 250 may determine commonalities across those applications and assess what is the minimum set of screens required to create variations of applications with the given purpose.

The system 250 may automatically determine the maximum number of screens required to create a fully featured application template (see FIG. 6) for a given purpose. By analyzing user generated applications for a concrete purpose, the system can determine what is the commonly acceptable maximum set of screens, required to create variations of applications with the same purpose.

The system 250 may allow users to assign custom alphanumeric tags to components within the database 252 for easy discovery. Within the system 250, users may tag application templates, application instances, screens, parts, elements, resources, resource collections.

Components within the system (e.g., parts, screens, applications, part dependencies) may be discovered by group name, component name, tags, descriptions, purpose, metadata, related screens, or any other data contained in the system.

The system 250 may use user generated tags to make recommendations of applications templates, screens, parts, elements, resources (see system intelligence).

The system 250 may capture, store, and analyze users' simple inputs to assign logical meaningful purpose (e.g., specify the purpose of a screen) to the automatically generated screens. When two or more user generated screens have the same purpose, the system can automatically inspect the virtual catalog and create a subset of screens of the same purpose of the user generated screens.

The system 250 may capture, store, and analyze users' simple input to assign logical meaningful purpose (e.g., specify the purpose of an application) to the automatically generated applications or application instance. When two or more user generated applications have the same purpose, the system can automatically determine the minimum and maximum number of screens required to create applications of the same purpose, and automatically generate applications of that purpose.

Assume, for example, that a user wishes to generate a new application 700 for the purpose (or function) F of disseminating news. Assume also that the virtual catalog 500 comprises three applications 702, 704, and 706 for this Function F, the pages 701 of which are set forth in FIG. 7. Specifically, application 702 may have four pages 702A, 702B, 702C, and 702D (i.e., a homepage, a page for listing news, a page for news details, and a contact us page, respectively), the application 704 may have four pages 704A, 704B, 704C and 704D (i.e., a homepage, a page for listing news, a page for news details, and a photo gallery page, respectively), and the application 706 may have four pages 706A, 706B, 706C, and 706D (i.e., a homepage, a page for listing news, a Facebook page, and a Twitter page, respectively). The system 250 may determine the minimum number (MIN) of pages 701 of the new application 700 by calculating the common pages (i.e., the pages having a common purpose) that are present in each of the applications 702, 704, 706. For example, in this example, the system 250 may determine that the homepage (i.e., pages 702A, 704A and 706A), and the list of news page (i.e., pages 702B, 704B, and 706B) are present in each of the applications 702, 704, 706, and thus, determine that the new application 700 will, at a minimum, have two pages (i.e., a home page and a page for listing news). Similarly, the system 250 may consider the unique pages 701 in the three applications 702, 704 and 706, and compute that the maximum number (MAX) of pages 701 in the new application 700 may be seven pages (i.e., a home page, a page for listing news, a page for news details, a page for contact us, a photo gallery page, a Facebook page, and a Twitter page). As can be appreciated, in determining the maximum number (MAX) of pages 701, the system 250 may not recount the pages having the same purpose (such as the homepages 702A, 704A and 706A).

The system 250 may allow users to create editable instances of screens or applications. Users can modify the concrete values (see Create an application instance) of any screen or application instance.

The system 250 may be capable of organizing, performing searches, and making recommendations of applications (see applications) and applications screens (see screens) that have not yet been created. These actions are performed against a subset of the virtual catalog 500 to which the system 250 may assign a purpose based on users' prior inputs.

Further, the system 250 may learn from users' simple inputs about how to identify the purpose of an automatically generated application template, screen, or parts.

The system 250 may aggregate parts and their dependencies to generate application screens, and may aggregate screens into a single interconnected application template. The system 250 may further combine parts into screen, screens into applications, and generate the required files to create an application. Further, the system 250 may host applications in the same computer device where the system is operating. Additionally, in addition to using parts 104 of pre-existing applications, the system 252 may allow users to create new parts 104 (e.g., by providing code for the new parts 104), which may exponentially increase the parts available to users.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub combinations are of utility and may be employed without reference to other features and sub combinations and are contemplated within the scope of the claims. Not all steps listed in the various figures need be carried out in the specific order described.

Also described herein are systems and methods for providing and/or deploying complete application delivery via an application programming interface, and may be referred to herein as “template-as-a-service” or a “template application programming interface” (“TAPI”). TAPI facilitates delivery software to a client application or consumer computer system in a manner that preserves consumer control over the final software, reduces or eliminates repetitive work, simplifies maintenance, and, if based upon the seed-based architecture described elsewhere herein, facilitates the creation of a complete software solution from interchangeable parts that are simple and easy to create.

Thus, TAPI may use the systems and methods for organizing, classifying, and discovering automatically generated computer software as described elsewhere herein, which is capable of creating millions of computer software interfaces for a given purpose. Such software can be organized and ranked to help understand which combinations are more effective for a given purpose. The resulting templates can then be stored in a database and used as templates for web applications, which are accessed and deployed through an API call, as further described elsewhere herein. Additionally and/or alternatively, templates can also be created and stored using other techniques, and accessed and deployed through an API call as described herein.

TAPI is an improvement over prior art technologies such as software as-a-service (“SaaS”), because in a SaaS deployment, a provider of a service will use software to deliver the service to multiple end-users, but TAPI allows a consumer to become a service provider and extend the capabilities of a base set of system functionality by using an API to deliver data from a TAPI system to a consumer computer server, from which the application services can then be provided to end-users.

Thus, whereas in a traditional implementation of an API, the consumer application must make a call to a third-party computer server and get data to be handled by the consumer application, TAPI combines multiple delivery mechanisms to simplify instantiation in the consumer's computing environment. Rather than copying capabilities that already exist, the TAPI approach facilitates improvements to existing software solutions that are standardized (whether by a standard-setting organization or de facto standardization via wide industry acceptance), and add new features and capability while also allowing consumers to maintain control over the final software application presented to the end-user.

TAPI thus replaces the traditional data flow model with a new one. In a TAPI implementation, an entire, complete application is provided in the response to an API call. The consumer becomes the access point to end-users for the application. The consumer data may be merged at the client side, or the API portion of the implementation may carry consumer data and the TAPI server merges that data into the application (e.g., a template definition, as described elsewhere herein) and returns code that instantiates the application in the consumer's computing environment. Thus, if a consumer wishes to create a file sharing solution (e.g., like DropBox™), an online video platform (e.g., like YouTube™), or an accounting solution (e.g., like QuickBooks™), a single TAPI call causes the consumer to become any one of these.

In a TAPI implementation, this same basic interaction takes place, except that the initial web page that is served contains only an API call to a TAPI system to download the application from a TAPI system, as described in more detail elsewhere herein. That is, while the web host/service provider may have a web server receiving and responding to HTTP requests, the application itself is not stored on or associated with that web server. Rather, upon loading, the web page makes an API call to a TAPI system, which then responds with the HTML and other materials (source code, data, images, etc.) required to deploy the web application.

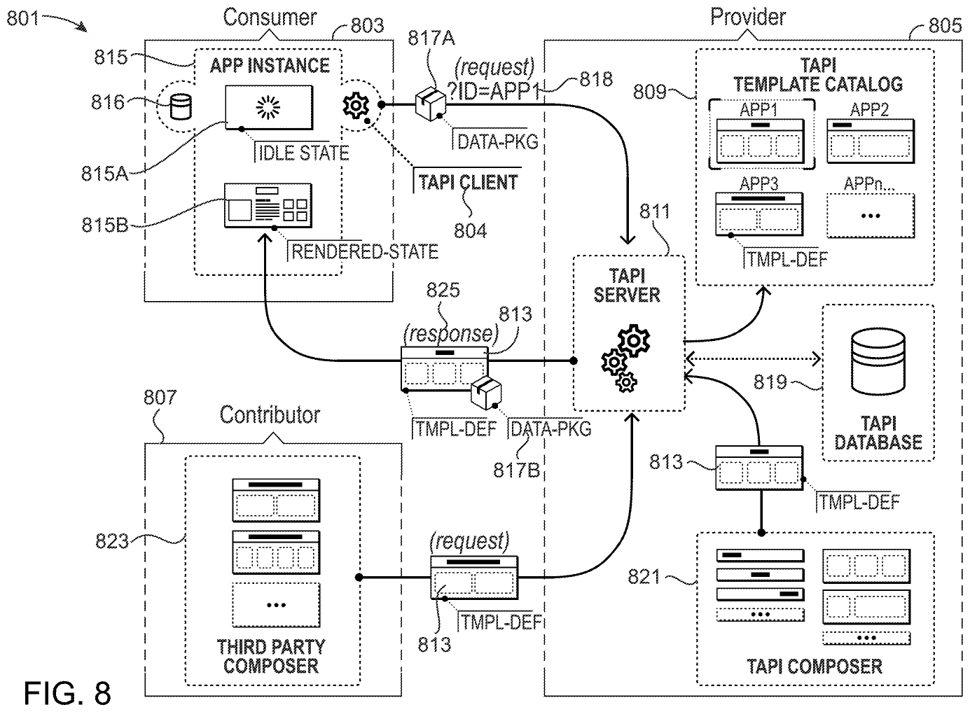

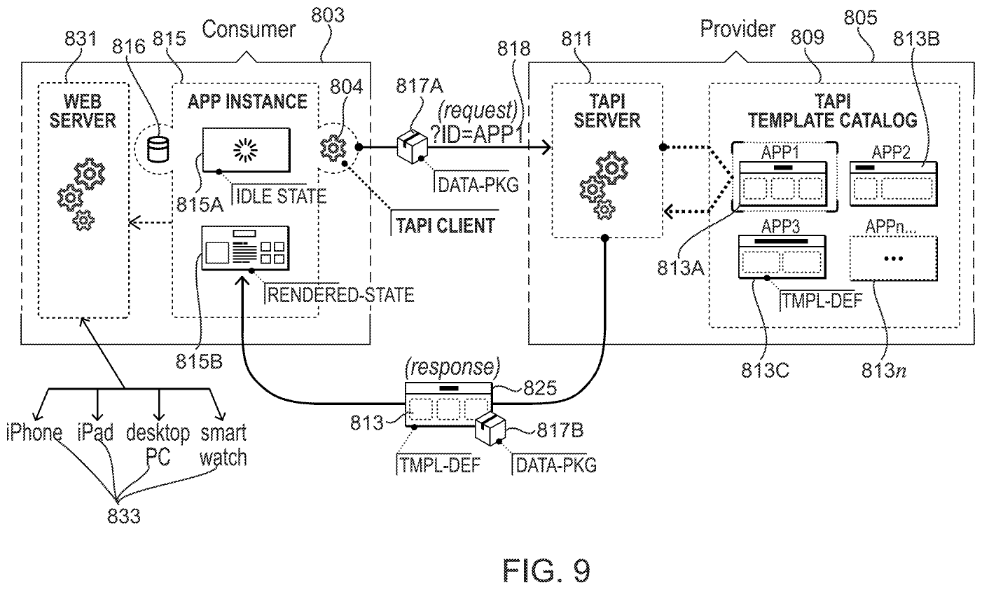

Embodiments of a TAPI implementation are depicted in FIGS. 8 and 9. At a high level of generality, the depicted TAPI systems and methods are comprised of two main subsystems: a consumer system 803, and a provider system 805. Additionally, other systems 807 can become contributors by adding application templates to the provider system 805 as described elsewhere herein. These are known as contributor systems 807.

For purposes of this disclosure, a “provider” refers to an enterprise or individual providing TAPI services, generally using a computing environment 805 having a TAPI server 811 programmed to receive and process requests from a consumer system 803 (e.g., a TAPI client 804). Among other things, the TAPI server 811 stores template definitions in a catalog 809, accepts template definitions, and modifies template definitions to facilitate further customization of such template definitions.

To utilize TAPI, a consumer 803 will first acquire and install, generally on the consumer system 803, software to perform certain functions described herein. This software 804 may be referred to herein as the TAPI client 804. Generally, the TAN client 804 communicates over a telecommunications network with a corresponding TAPI server 811, which is running on a provider system 805.

The TAPI client 804 may be implemented as a software module, component, or a collection or set of software modules or components, designed to run on the particular hardware and operating system platform 803 used by the consumer. The TAPI client 804 is generally designed and programmed to take advantage of the features and functions available on that platform 803. For example, if the consumer environment 803 is a data center, the TAPI client 804 may have features and functions that enable it to utilize power monitoring and database facilities in the data center. By contrast, if the consumer environment 803 is a mobile device platform, the TAPI client 804 may instead be programmed to use features such as location services, onboard imaging devices, the microphone and the like. Common functions of the TAPI client 804 are to collect and manage the data 816 relevant to the application instance 815, pre-processing of such data 816, sharing data with other systems, requesting a template definition 813 from a TAPI server 811, storing, and caching data in the consumer system.

A person of ordinary skill in the art, upon reading this disclosure, will know how to create a TAPI client 804 for a particular environment, such as by using software development kits, compilers, integrated development environments, and other widely used development tools and techniques for the platform 803 on which the TAPI client 804 is to run.

Likewise, a person of ordinary skill in the art will understand how to program the web services elements of the TAPI client 804 in order to make the API calls described herein, such as, without limitation, receiving the responses described herein and displaying the resulting application. In a typical embodiment, the consumer may be required to establish authentication credentials with the provider in order for the particular TAPI client 804 to communicate with and receive services from the corresponding TAPI server 811.

When the TAPI client 804 is first installed, it is in an idle state 815A in which there is no instance of an application 815 active on the consumer system 803. Once the TAPI client 804 is configured with the consumer's authentication credentials to access and use the corresponding TAPI server 811, the credentials and a data package 817A may be prepared for transmission to the corresponding TAPI server 811, usually hosted on a provider system 805.

For purposes of this disclosure, data package 817A refers to data that is relevant to the application instance 815 and used to generate the final output of the application (i.e., the rendered state 815B). This data may include text-based data, binary data, and references to external data sources that can be included in the application output.

The consumer credentials may be packaged as, for example, a key value pair, or may use other authentication techniques in accordance with the applicable communications standard (e.g., HTTP or HTTPS), and the data package 817A is likewise prepared for transmission using similar techniques, or other techniques known in the art. The content of the data package 817A will generally be consumer-specific configuration data 816 which will be used, as described elsewhere herein, by the TAPI server 811 to create a requested application and customize it for the particular consumer. Among other things, the data package 817A may include an indication 818 of which template definition 813 will be used to generate the application 815.

As used herein, a “template definition” 813 is an application that can run inside a consumer system environment 803. This application is typically a web application, but the systems and methods described herein may be applicable to other types of software delivery as well and are not necessarily limited to web applications. The template definitions 813 are thus (as defined elsewhere herein) generally a collection of functional user interfaces grouped together to create application workflows intended to serve a particular purpose or achieve a particular task or outcome. The components of the template definition 813 (e.g., headers, forms, footers, etc.) are usually chosen to meet that specific need. All the parts required to render an application are collectively expressed as a template definition.

Each template definition 813 may be uniquely identifiable by a template definition identifier. This identifier may be, for example, a serial number, a unique identifier (UID), or a uniformly unique identifier (UUID). In an embodiment, the data package may indicate which template definition 813 will be used to generate the application by providing the template definition identifier associated with the desired template 813.

Once the TAPI client has bundled the consumer credentials and data package 817A, the TAPI client 804 opens a connection to a TAPI server 811 and transmits the consumer credentials and data package 817A in a request to generate the corresponding application instance 815B. This may be done, by way of example and not limitation, using the POST facility of the HTTP or HTTPS protocol, or another data exchange standard. This request is generally made using a telecommunications network, generally the public Internet, and is received by the TAPI server 811 at the provider system 805.

The TAPI server 811, upon receipt of the data package 817A from the TAPI client may 804 conduct a validation step. This step may include examining the authentication credentials and confirming that the TAPI client 804 in question is indeed authorized to receive the requested template definition or other requested services from the TAPI server 811 and/or the provider system 805. This may further comprise checking that the authentication credentials are correct and valid, and are not, for example, expired, suspended, or otherwise flagged for non-service. If the authentication credentials are not authorized to receive the application instance 815B, an error message may be generated and returned using the same protocol, or otherwise as known in the art (e.g., by simply closing the TCP socket at the TAN server 811).

Likewise, the TAPI server 811 may examine the data package 817A to confirm that its content is valid and conforms to the communication protocol the TAPI client 804 and TAPI server 811. This step may include typical data checks, such as to confirm that required fields are present, and that optional fields are known or recognized. If an unrecognized field or data element is found, the TAPI server 811 may attempt to continue to serve the request regardless, and may optionally note the unrecognized or unused data in a return message, so that the TAPI client 804 can be informed that certain data in the data package 817A was not used or could not be understood. Alternatively, the TAPI server 811 may reject the request entirely. These particulars depend upon the communications standards established between the TAPI client 804 and the TAPI server 811, and/or the preferences of the provider.

If the data package 817B is validated, and the TAPI server 811 determines that the request can be acted upon, the TAPI server 811 then acquires the corresponding template definition 813 from its internal database 819, and sends it in a response data package 817B to generate an application instance 815B as output to be returned back to the consumer system 803 in response 817B to the request 817A. This template definition is received by the consumer system 803 and, together with consumer data 816 used to render an application instance 815B based on the template definition 813. This application instance 815B output may be referred to herein as the “rendered state.”

There are a number of ways that consumer data 816 may be accessed and used by the rendered application. In one embodiment, the TAPI client 804 provides access to local resources to the rendered application 815B. This may be done by the rendered application 815B including programming that invokes an API to access to local resources. That is, a TAPI implementation may use a standardized API for access to local resources (e.g., consumer data 816) and the template definition 813 may use that API to provide a generic interface to such local resources, allowing the template definition 813 to use the same interface with multiple consumers.

By way of example and not limitation, this may be done via a JavaScript API. A rendered application 815B could use JavaScript to access the consumer file system, such as by invoking a terminal object to execute a file system level command, such as “ls.” In this case “ls” will run locally in a terminal at the consumer system 803, and the response converted to a JavaScript object by the TAPI library. This approach will also allow access to programming languages installed in the consumer system 803 (e.g., “var php_version=tapiJS.terminal.run('php-v′)”) or to a third party system database, such as Wordpress™ (e.g., “var posts=tapiJS.wordpress.get_posts( )”).

In general, accessing data comprises: (1) a TAPI client 804 installed in the consumer environment 803 (providing access to resources in the consumer environment 803); (2) registering an endpoint that can be access by the application instance 815, and, preferably, only by the particular application instance 815 (e.g., an API endpoint); and (3) a library/API to expose functionality in the TAPI client 804 to the application instance 815 (e.g., via JavaScript/AJAX). Typically, access to consumer data 816 is normalized by the library. Thus, regardless of the particular platform used by the consumer environment 803 hosting the TAPI client 804, each application instances 815 for a given template definition 813 may be written to use the same API to access local resources without platform-specific considerations. For example, getting a list of files could be normalized as “var files=tapiJS.filesys.list( )).” This API call would exhibit the anticipated functionality regardless of the platform in which it runs (e.g., whether the consumer system 803 is UNIX, Linux, Windows, etc.)

This application instance 815B is, effectively, a complete application ready and capable for rendering and/or display by the TAPI client 804 in order to provide the application services in question to end-users 833 (typically of the consumer). By way of example, and not limitation, the generated output may be a complete HTML web page including implementing a web application. The TAPI client 804 simply presents this output to end-users 833 contacting the consumer's web server 831, thereby providing the rendered application 815B to the consumer's end-users 833. This in turn means that the consumer's own web site may be as simple as a single web page whose primary content is the API call to the TAPI server 811, which does the work of generating the website.

The template definitions 813 may be created using the systems and methods described elsewhere in this application, as well as in U.S. patent application Ser. No. 16/868,309 filed May 6, 2020, and U.S. pat. application Ser. No. 14/185,602, filed Feb. 20, 2014, and now issued as U.S. Pat. No. 10,671,359, and U.S. Provisional Patent Application No. 61/767,757 filed Feb. 21, 2013. The disclosures of all of these documents are incorporated herein by reference in their entirety. Accordingly, the template definitions 813 may be formed from a set combination of one or more parts (e.g., headers, forms, footers, etc.), wherein each is identified as being associated with a given purpose (e.g., an authentication screen). The combination of the set of one or more parts and the purpose is combined to generate a “screen.” A set combination of one or more screens associated with the purpose is the software application. The software application is then bundled as a template definition 813. A software package that implements the foregoing systems and methods to generate template definitions that can later be shared with one or more consumer systems is referred to herein as a “composer” 821 or “TAPI composer” 821.

In an embodiment, a composer 821 may further provide functionality for application publishers to create application templates and to place those creating in a catalog 809. A composer 821 may provide the ability to create, modify, and/or remove template definitions 813 that have been placed inside the template catalog 809. In an embodiment, a composer 821 may also provide extended functionality for creating template definitions 813 using alternative systems and methods. A composer 821 providing this extended functionality for creating template definitions 813 using alternative systems and methods is an “extended composer.”

A composer 821 may be used to create template definitions 813 and submit them to the TAPI server 811 for validation. If the templates 813 are valid, then they may be added to a template catalog 809. As shown in the depicted embodiment, the template catalog 809 is a data collection to which the TAPI server 811 has access, and is associated with the provider's system 805. However, in an alternative embodiment, the template catalog 809 may be in a separate database or part of a separate system, accessible to the TAPI server 811. When a new template definition is submitted and validated, and added to the catalog, a pointer to the new entry may be returned to another element of the provider system 805, the TAPI composer 821 (described elsewhere herein).

The validation of a template definition 813 may comprise code validation to confirm that the component elements (e.g., the HTML, JavaScript, and CSS code) is well-formed and/or standard-compliant. This may prevent the delivery of a template definition 813 having defective code to a TAPI client 804.

Since the merging of code and data occurs primarily at the TAPI server 811 (e.g., via the use of the API calls described elsewhere herein), data tokens may also be validated. A data token can be thought of as a code snippet that can be inserted, usually within the HTML code, and which is replaced with data values. For example, “<h1>Welcome to {$company.name}'s website</h1>”. In this example, the TAPI server 811 will recognize “{$company.name}” as a special code (e.g., using regular expressions or other text-parsing technologies) and replace that value with the name of the consumer company. That data would be included in the data package 817A sent by the TAPI client 804. If {$company.name} is not available (i.e., the TAPI client 804 failed to include that data element in the request, the TAPI server 811 may include in the response a warning or error message indicating that the data was missing. The TAPI server 811 may also verify whether tokens are valid. Invalid tokens may produce a broken page output (e.g., unclosed token “<h1>Welcome to {$company.name's website</h1>”. Likewise, linked resources (images, videos, fonts, etc.) are preferably validated to ensure the page can be fully rendered and that resources are accessible and present.

Although the template definitions 813 can be created and defined by the consumer 803 in an embodiment, third party contributors 807 may also create and design templates 813. In such an embodiment, the third party consumer 807 could use its own composer 821 software 823 to authenticate a request to access the TAPI server 811. The third party 807 may then also create a template definition 813, and submit it to the TAPI server 811 for validation and addition to the template catalog 809. A pointer to the new entry may then be returned to the third party composer 823 (i.e., the unique identifier 818 of a template definition).

In an embodiment, TAPI could also provide push technology for search engines. That is, on a regular basis, search engines use software to discover and index content from public web sites on the Internet. If there are no updates or changes to a given site, this effort is wasted, consuming electricity, processing power, and network bandwidth. Since a TAPI implementation provide a centralized architecture, the TAPI system has knowledge of any changes in a web site that uses a TAPI template definition, and thus can notify search engines when a change occurs, and provide any changed data, but without the need to transmit the rest of the web site. This can reduce the number of trips made by the bots while also keeping the search engine index more current.

TAPI provides several solutions to the problems in the prior art. First, TAPI brings together entire unrelated and disparate software application platforms (e.g., YouTube, Dropbox, QuickBooks), rather than merely stitching together functionality (e.g., payment, authentication, file upload). Second, TAPI reduces the effort required to develop software and deliver the final product to multiple recipients in a consistent manner. Third, TAPI offers a direct path to publishing software templates from a marketplace directly into a consumer system, using live or test consumer data, and bypassing the need to buy in advance and/or go through the hassle of installing and configuring a third party template only to discover that it does not work for the desired purpose or with the consumer's particular data. Instead, consumers can preview the entire application before buying a template, using the consumer's own data, by receiving a fully instantiated application in their system via a TAPI call to preview, and, once a template is purchased, having immediate access to a fully functional application. Fourth, TAPI provides a simple channel of communication that can be used to integrate independently generated software templates with consumers without requiring custom work.

There other benefits as well, including, but not limited to: centralized management; a lightweight system; putting consumers are in control of the data and underlying capability required by a template definition, allowing the TAPI server to specialize in the storage and merge functions based on requests; remote hosting; network-accessible; easier legal compliance (e.g., Americans with Disabilities Act); consumers are not responsible for hardware or software updates; consumers can preview an entire software or website before buying or installing; one-click installation; the consumer's proprietary data remains in the consumer's system; consumers can create their own templates or choose from templates created by third party contributors; application-specific code can be modified without affecting the consumer system; a single applications can be shared with or used by multiple consumers, each by using each consumer's own data, but without compromising the proprietary data of any consumer; avoid a single failure point architecture; enhanced version control of the software application; faster and easier rollout of new releases; ability to easily roll back unwanted changes; applications run in the context of the consumer's server; clients can choose, replace, and discontinue using TAPI at any time; development continuity, since the application is hosted in TAPI, not a single computer system; simplified security and reduction in consumers responsibility; uniform security patching and vulnerability assessment and remediation.

By way of example and not limitation, the provider system 805 may use load balancing to manage server overload and data redundancy to protect against cyber-attacks and downtime. Still further, versioning of the template definitions 813 can provide safe updating with rollback. For example, when a template definition 813 is published, a unique identifier (i.e., pointer or GUID) is created and a version is assigned to the template definition 813. If a security-related issue is discovered, the template definition can be patched and either the changes are immediately available and for all TAPI clients 804 using that template definition 813, or a new identifier is generated and TAPI clients 804 may optionally opt-in (request the new identifier) to receive the updated version.

In another embodiment, the TAPI server 811 may implement limited server-to-server communication restricted to specific whitelisted clients (e.g., via an IP address whitelist). This minimizes the risk of a cyber-attack and, even if one occurs, the template definition 813 is an empty container, and potentially sensitive resources are hosted on the consumer system 803. Thus, even in the event of a successful attack of the TAPI provider 805, the attacker will not receive any consumer data 816.

It is also important to understand what TAPI is not. TAPI should not be confused with a domain name or server redirect, where the consumer's domain name is merely forwarded to a provider server. In that scenario, the provider server is in control of the software, not the consumer, and the provider server services client connections directly. Further enhancements are thus the responsibility of the provider. Instead, TAPI captures the creation and publishing of application templates and the distribution methodology, allowing a consumer system to instantiate and customize an application template. TAPI is also not a mere server-side rendering. Server-side rendering fails to decouple a predefined design from instance-specific data. With TAPI, designs are data-agnostic and can be created without knowledge of the consumer, end-user, or data.

To better understand a TAPI implementation, consider the example of a law firm (a consumer) that desires to create a file-sharing solution to allow exchanging documents between lawyers and clients, including an approval process unique to that law firm. Building an entire file sharing system from scratch would be an expensive and time-consuming undertaking. An off-the-shelf third party solution provides only a partial answer because it lacks the custom functionality of the approval process.

Using TAPI, the law firm could select an existing file sharing solution template definition (similar in concept to DropBox™, Google Drive™, and the like) and instantiate the application within the law firm's own system from a simple API request, while also maintaining control over the law firm's own software environment (including the firm's data stored in it). The custom functionality can be added in the Consumers system or the TAPI system by simply intercepting data at a given point during the application lifecycle (e.g. when a file is done uploading).

By way of example and not limitation, suppose a TAPI consumer wished to implement custom functionality when a file is uploaded. A template definition 813 may be selected which implements a hosted file sharing function (e.g., a DropBox™-like application). After a file is uploaded, the template definition 813 is programmed to open another page with a custom web application, which is not part of the standard template definition 813, built and hosted separately. This customized functionality can perform whatever additional features/functions are needed for the particular use case.

By way of another illustrative, non-limiting example, suppose a consumer desires to create a movie streaming service for the visually impaired which includes audible descriptions of scenes, characters, and other visual information in the film. With a single API call, the consumer can instantiate an entire video delivery system (e.g., similar to YouTube™ or an on-line streaming service). TAPI will allow the consumer to layer new functionality such as an audio track for visually impaired users over the video, without having to build a video streaming application from scratch.

The line between a web page/web site and a “web app” is generally drawn on the basis of design and functionality. That is, a “web page” or “web site” becomes a “web application” when its design implements the type of functionality and feature set traditionally associated with desktop software applications. In particular, a design using only single web page may be considered more like an application because it does not implement a defining characteristic of the early web, which is the HTML feature of interlinking and cross-referencing among multiple separate logical documents stored on the web server, each of which must be loaded separately.

Although this disclosure is concerned primarily with web applications, a person of ordinary skill will recognize potential application in other technologies as well. The more general term “applications” will thus be used throughout this disclosure, with the understanding that it encompasses web applications.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for instantiating a web application comprising:
providing a consumer computer system comprising:
web server software; and
a consumer database comprising consumer data;
providing a provider computer system comprising:
a template database comprising a plurality of template definitions, each of said template definitions in said plurality of template definitions having a unique template definition identifier;
receiving, at said provider computer system, a request from said consumer computer system to generate a complete web application from a requested template definition, said requested template definition being a template definition in said plurality of template definitions, and said request including said unique template definition identifier of said requested template definition;
said provider computer system responding to said request by forming a data package comprising a copy of said requested template definition retrieved from said template database;
receiving, at said consumer computer system, said response;
rendering, at said consumer computer system, said complete web application from said received requested template definition and from said consumer data retrieved from said consumer database; and
serving, at said consumer computer system, said rendered complete web application via said web server software.

2. The method of claim 1, further comprising:
providing a composer database of screen seeds and parts, each screen seed being capable of having at least one part positioned on a position thereon;
wherein at least one template definition in said plurality of template definitions is generated by:
selecting a screen seed from said composer database;
populating said screen seed with parts from said composer database;
assigning said screen a screen purpose; and
repeating said selecting, populating and assigning to create a set of screens, each of said screens in said set having said screen seed and said screen purpose;
accessing said set of screens and giving each of said screens in said set of screens a lowest ranking;
making at least one new screen comprising said screen seed populated with an unused combination of parts previously populated on at least one of said screens in said set of screens;
associating each of said at least one new screens with said screen purpose;
increasing said ranking of said screens in said set of screens;
giving each of said new screens a lowest ranking;
merging said new screens into said set of screens;
storing said set of screens in said composer database;
making a first application, said first application comprising two or more screens from said composer database;
assigning said first application an application purpose; and
making a second application, said second application comprising two or more screens from said composer database, at least one of said two of more screens of said second application having a common screen purpose with at least one of said two of more screens of said first application;
creating a minimum screen requirement for said application purpose, said minimum screen requirement comprising all said common screen purposes between said first application and said second application;
generating at least one application template for said application purpose, said application template including at least one screen, said application template meeting said minimum screen requirement for said application purpose; and
storing said generated application template in said template database as a template definition.

3. The method of claim 2, wherein said at least one template definition is generated by a user of said consumer computer system.

4. The method of claim 2, wherein said at least one template definition is generated by a user of a contributor computer system.

5. The method of claim 1, further comprising:
receiving, at said consumer computer system from an end-user device, a request for web services; and
providing to said end-user device, via said rendered complete web application, said requested web services.

6. The method of claim 5, wherein said requested web services comprise at least some of said consumer data.

7. The method of claim 1, further comprising:
providing a second consumer computer system comprising:
a second web server software; and
a second consumer database comprising second consumer data;
receiving, at said provider computer system, a second request from said second consumer computer system to generate a second complete web application from said requested template definition, and said second request including said unique template definition identifier of said requested template definition;
said provider computer system responding to said second request by forming a second data package comprising a second copy of said requested template definition retrieved from said template database;
receiving, at said second consumer computer system, said response;
rendering, at said second consumer computer system, said second complete web application from said received requested template definition and from said second consumer data retrieved from said second consumer database; and
serving, at said second consumer computer system, said second rendered complete web application via said second web server software.

8. The method of claim 7, further comprising:
receiving, at said second consumer computer system from a second end-user device, a second request for web services; and
providing to said second end-user device, via said second rendered complete web application, said second requested web services.

9. The method of claim 8, wherein said second requested web services comprise at least some of said second consumer data.

10. A system for instantiating a web application comprising:
a consumer computer system comprising:
web server software; and
a consumer database comprising consumer data;
a provider computer system comprising:
a template database comprising a plurality of template definitions, each of said template definitions in said plurality of template definitions having a unique template definition identifier;
wherein said consumer computer system and said provider computer system each comprise at least one non-transitory computer-readable medium having program instructions thereon which, when executed by a microprocessor, cause said consumer computer system and said provider computer system to perform the following steps:
receiving, at said provider computer system, a request from said consumer computer system to generate a complete web application from a requested template definition, said requested template definition being a template definition in said plurality of template definitions, and said request including said unique template definition identifier of said requested template definition;
said provider computer system responding to said request by forming a data package comprising a copy of said requested template definition retrieved from said template database;
receiving, at said consumer computer system, said response;
rendering, at said consumer computer system, said complete web application from said received requested template definition and from said consumer data retrieved from said consumer database; and
serving, at said consumer computer system, said rendered complete web application via said web server software.

11. The system of claim 10, further comprising:
a composer database of screen seeds and parts, each screen seed being capable of having at least one part positioned on a position thereon;
wherein at least one template definition in said plurality of template definitions is generated by said program instructions causing said consumer computer system and said provider computer system to perform the following steps:
selecting a screen seed from said composer database;
populating said screen seed with parts from said composer database;
assigning said screen a screen purpose; and
repeating said selecting, populating and assigning to create a set of screens, each of said screens in said set having said screen seed and said screen purpose;
accessing said set of screens and giving each of said screens in said set of screens a lowest ranking;
making at least one new screen comprising said screen seed populated with an unused combination of parts previously populated on at least one of said screens in said set of screens;
associating each of said at least one new screens with said screen purpose;
increasing said ranking of said screens in said set of screens;
giving each of said new screens a lowest ranking;
merging said new screens into said set of screens;
storing said set of screens in said composer database;
making a first application, said first application comprising two or more screens from said composer database;
assigning said first application an application purpose; and
making a second application, said second application comprising two or more screens from said composer database, at least one of said two of more screens of said second application having a common screen purpose with at least one of said two of more screens of said first application;
creating a minimum screen requirement for said application purpose, said minimum screen requirement comprising all said common screen purposes between said first application and said second application;
generating at least one application template for said application purpose, said application template including at least one screen, said application template meeting said minimum screen requirement for said application purpose; and
storing said generated application template in said template database as a template definition.

12. The system of claim 11, wherein said at least one template definition is generated by a user of said consumer computer system.

13. The system of claim 10, wherein said at least one template definition is generated by a user of a contributor computer system.

14. The system of claim 10, wherein said program instructions further cause said consumer computer system to perform the following steps:
receiving, at said consumer computer system from an end-user device, a request for web services; and
providing to said end-user device, via said rendered complete web application, said requested web services.

15. The system of claim 5, wherein said requested web services comprise at least some of said consumer data.
